(19) United States
(12) Patent Application Publication
(10) Pub. No.: US 2016/0289516 A1
(43) Pub. Date: Oct. 6, 2016

(54) WATER-DISPERSIBLE PRESSURE-SENSITIVE ADHESIVE COMPOSITION FOR OPTICAL FILM, PRESSURE-SENSITIVE ADHESIVE LAYER, PRESSURE-SENSITIVE ADHESIVE OPTICAL FILM, AND IMAGE DISPLAY DEVICE

(71) Applicant: NITTO DENKO CORPORATION, Ibaraki-shi, Osaka (JP)

(72) Inventors: Yousuke Makihata, Ibaraki-shi (JP); Kenichi Okada, Ibaraki-shi (JP); Toshitaka Takahashi, Ibaraki-shi (JP); Kayo Shimokawa, Ibaraki-shi (JP); Taiki Shimokuri, Ibaraki-shi (JP); Toshitsugu Hosokawa, Ibaraki-shi (JP); Kunihiro Inui, Ibaraki-shi (JP)

(73) Assignee: NITTO DENKO CORPORATION, Ibaraki-shi, Osaka (JP)

(21) Appl. No.: 15/036,646

(22) PCT Filed: Jun. 10, 2014
(86) PCT No.: PCT/JP2014/065336

§ 371 Date: May 13, 2016

(30) Foreign Application Priority Data
Nov. 15, 2013 (JP) 2013-237192

(51) Int. Cl. C09J 133/12; B32B 27/06; G02B 1/14; B32B 7/12; C09J 7/02; G02B 5/30

(52) U.S. Cl. CPC C09J 133/12; C09J 7/0217; G02B 5/3033; G02B 1/14; B32B 7/12; B32B 27/06; C09J 2483/005; C09J 2203/318; B32B 2307/40

(57) ABSTRACT

A water-dispersible pressure-sensitive adhesive composition for an optical film includes emulsion particles each having a core-shell structure in which (A) a (meth)acryl copolymer forms a core layer and (B) a (meth)acryl copolymer forms a shell layer in a single emulsion particle, wherein the (meth)acryl copolymer (A) includes a monomer unit derived from an alkyl (meth)acrylate, the (meth)acryl copolymer (B) includes a monomer unit derived from an aromatic ring-containing (meth)acrylic monomer and a monomer unit derived from an alkyl (meth)acrylate, and a content of the monomer unit derived from the aromatic ring-containing (meth)acrylic monomer in the (meth)acryl copolymer (B) is from 1 to 28% by weight based on the total weight of monomer component used to form the (meth)acryl copolymers (A) and (B).

### TECHNICAL FIELD

The invention relates to a water-dispersible pressure-sensitive adhesive composition for an optical film, a pressure-sensitive adhesive layer made from the water-dispersible pressure-sensitive adhesive composition, a pressure-sensitive adhesive optical film including an optical film and the pressure-sensitive adhesive layer provided on at least one side of the optical film. The invention also relates to an image display device, such as a liquid crystal display device, an organic electroluminescent (EL) display device, a cathode ray tube (CRT), a plasma display panel (PDP), produced with the pressure-sensitive adhesive optical film.

### BACKGROUND ART

Image display devices such as liquid crystal display devices (LCD), organic EL display devices, etc. have an image-forming mechanism including polarizing elements as essential components. For example, therefore, in a liquid crystal display device, polarizing elements are essentially placed on both sides of a liquid crystal cell, and generally, polarizing plates are attached as the polarizing elements. Besides polarizing plates, various optical elements have been used in display panels such as liquid crystal panels and organic EL panels for improving display quality. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, antiglare treatment films for preventing glare on image display devices, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together generally reduce optical loss. Therefore, a pressure-sensitive adhesive is used to bond the materials together. In such a case, a pressure-sensitive adhesive optical film including an optical film and a pressure-sensitive adhesive layer previously formed on one side of the optical film is generally used, because it has some advantages such as no need for a drying process to fix the optical film.

Pressure-sensitive adhesives for such optical film applications are required not to cause defects such as peeling and lifting (or to have durability to heat and humidity) in endurance tests, which are usually performed as accelerated environmental tests under heating and humidifying conditions or other conditions, and also required to possess such optical properties as to have no influence on the optical properties of optical films. Such optical properties are evaluated based on whether and how pressure-sensitive adhesive optical films cause white spot-induced display unevenness at their peripheral parts (peripheral unevenness or corner unevenness).

Known pressure-sensitive adhesive compositions for optical film applications include, for example, a pressure-sensitive adhesive composition containing an acryl-based polymer including monomer units derived from an alkyl (meth)acrylate and a ring structure-containing (meth)acrylate; and a pressure-sensitive adhesive composition (for an optical film) containing a (meth)acryl-based polymer including a specific amount of a benzyl (meth)acrylate unit (see, for example, Patent Documents 1 and 2).

### PRIOR ART DOCUMENTS

### Patent Documents

Patent Document 1: JP-A-2008-170949
Patent Document 2: JP-A-2011-105918

### SUMMARY OF THE INVENTION

### Problems to be Solved by the Invention

In recent years, pressure-sensitive adhesive compositions have also been required to be reduced in organic solvent content in view of a reduction in environmental loading substances, and solvent-type pressure-sensitive adhesives produced with organic solvents have needed to be replaced with water-dispersible pressure-sensitive adhesives produced with water as a dispersion medium. Patent Documents 1 and 2, which describe solvent-type pressure-sensitive adhesive compositions, do not show any study on what durability to heat and humidity or what optical properties (display unevenness) can be possessed by pressure-sensitive adhesive layers made from water-dispersible pressure-sensitive adhesive compositions.

Conventionally known water-dispersible pressure-sensitive adhesives are considered to still have insufficient performance for optical applications as compared with solvent-type pressure-sensitive adhesives, and, particularly, do not satisfy requirements for optical properties and durability to heating and humidification. For example, it has been found that a pressure-sensitive adhesive optical film having a pressure-sensitive adhesive layer made from a water-dispersible acrylic pressure-sensitive adhesive can cause the pressure-sensitive adhesive layer to deform and have an optical retardation through the process of bonding the pressure-sensitive adhesive layer to glass and then heating and humidifying it. The retardation is caused by nonuniform shrinkage of the pressure-sensitive adhesive layer during heating and humidification (specifically, the shrinkage is small at the center of the pressure-sensitive adhesive layer and large at the end of it), so that the pressure-sensitive adhesive optical film having the pressure-sensitive adhesive layer can cause display unevenness.

It is therefore an object of the invention to provide an water-dispersible pressure-sensitive adhesive composition that is for use on an optical film and capable of forming a pressure-sensitive adhesive layer having high durability to heat and humidity and not causing display unevenness when deposited on an optical film to form a pressure-sensitive adhesive optical film, and to provide a pressure-sensitive adhesive layer made from such a water-dispersible pressure-sensitive adhesive composition for an optical film. It is another object of the invention to provide a pressure-sensitive adhesive optical film including an optical film and the pressure-sensitive adhesive layer provided on at least one side of the optical film, and to provide an image display device having such a pressure-sensitive adhesive optical film.

### Means for Solving the Problems

As a result of intensive studies to solve the problems, the inventors have accomplished the invention based on findings that the objects can be achieved by means of the water-dispersible pressure-sensitive adhesive composition described below for an optical film.

The invention relates to a water-dispersible pressure-sensitive adhesive composition for an optical film,

the composition comprising:

emulsion particles each having a core-shell structure in which (A) a (meth)acryl copolymer forms a core layer and (B) a (meth)acryl copolymer forms a shell layer in a single emulsion particle, wherein

the (meth)acryl copolymer (A) comprises a monomer unit derived from an alkyl (meth)acrylate,

the (meth)acryl copolymer (B) comprises a monomer unit derived from an aromatic ring-containing (meth)acrylic monomer and a monomer unit derived from an alkyl (meth)acrylate, and

a content of the aromatic ring-containing (meth)acrylic monomer in the (meth)acryl copolymer (B) is from 1% by weight to 28% by weight based on the total weight of monomer component used to form the (meth)acryl copolymers (A) and (B).

In the water-dispersible pressure-sensitive adhesive composition, the (meth)acryl copolymer (A) preferably has a glass transition temperature of 0° C. to 180° C., and the (meth)acryl copolymer (B) preferably has a glass transition temperature of −55° C. to less than 0° C.

In the water-dispersible pressure-sensitive adhesive composition, the aromatic ring-containing (meth)acrylic monomer is preferably benzyl acrylate.

The invention also relates to a pressure-sensitive adhesive layer made from the water-dispersible pressure-sensitive adhesive composition for an optical film.

The invention also relates to a pressure-sensitive adhesive optical film comprising an optical film and the pressure-sensitive adhesive layer provided on at least one side of the optical film, and an image display device comprising the pressure-sensitive adhesive optical film.

### Effect of the Invention

According to the invention, the water-dispersible pressure-sensitive adhesive composition for an optical film includes emulsion particles having a core-shell structure in which the (meth)acryl copolymer (B) containing the specified amount of a monomer unit derived from an aromatic ring-containing (meth)acrylic monomer forms the shell layer. The pressure-sensitive adhesive layer made from the pressure-sensitive adhesive composition with such features have durability to heat and humidity, and the pressure-sensitive adhesive optical film having the pressure-sensitive adhesive layer with such features can be kept from causing display unevenness.

### MODE FOR CARRYING OUT THE INVENTION

1. Water-Dispersible Pressure-Sensitive Adhesive Composition for an Optical Film

The water-dispersible pressure-sensitive adhesive composition of the invention for an optical film includes emulsion particles each having a core-shell structure in which (A) a (meth)acryl copolymer forms a core layer and (B) (meth)acryl copolymer forms a shell layer in a single emulsion particle, wherein

the (meth)acryl copolymer (A) includes a monomer unit derived from an alkyl (meth)acrylate,

the (meth)acryl copolymer (B) includes a monomer unit derived from an aromatic ring-containing (meth)acrylic monomer and a monomer unit derived from an alkyl (meth)acrylate, and a content of the aromatic ring-containing (meth)acrylic monomer in the (meth)acryl copolymer (B) is from 1% by weight to 28% by weight based on the total weight of monomer component used to form the (meth)acryl copolymers (A) and (B).

The (meth)acryl copolymer (B) that forms the shell layer includes monomer units derived from an aromatic ring-containing (meth)acrylic monomer and an alkyl (meth)acrylate. The term “alkyl (meth)acrylate” refers to alkyl acrylate and/or alkyl methacrylate, and “(meth)” is used in the same meaning in the description.

In view of emulsion polymerization reactivity, the alkyl (meth)acrylate preferably has a water solubility in a specific range, and an alkyl acrylate having an alkyl group of 1 to 18 carbon atoms is preferably used to form a major component, so that the glass transition temperature can be easily controlled. Examples of the alkyl acrylate include methyl acrylate, ethyl acrylate, propyl acrylate, n-butyl acrylate, tert-butyl acrylate, n-hexyl acrylate, cyclohexyl acrylate, 2-ethylhexyl acrylate, n-octyl acrylate, lauryl acrylate, tridecyl acrylate, stearyl acrylate, and other alkyl esters of acrylic acid. These may be used alone or in combination of two or more. Among these, an alkyl acrylate having an alkyl group of 3 to 9 carbon atoms is preferable, such as n-butyl acrylate, 2-ethylhexyl acrylate, or n-octyl acrylate. The content of the alkyl acrylate(s) is preferably from 50 to 99.9% by weight, more preferably from 50 to 90% by weight, even more preferably from 55 to 90% by weight, still more preferably from 55 to 80% by weight, based on the total weight of monomer component used to form each of the (meth)acryl copolymer (B).

An alkyl methacrylate having an alkyl group of 1 to 18 carbon atoms may be used as an alkyl (meth)acrylate. Examples of the alkyl methacrylate include methyl methacrylate, ethyl methacrylate, propyl methacrylate, n-butyl methacrylate, tert-butyl methacrylate, n-hexyl methacrylate, cyclohexyl methacrylate, 2-ethylhexyl methacrylate, n-octyl methacrylate, lauryl methacrylate, tridecyl methacrylate, stearyl methacrylate, isobornyl methacrylate, and other alkyl esters of methacrylic acid. These may be used alone or in combination of two or more. Among these, methyl methacrylate, ethyl methacrylate, and cyclohexyl methacrylate are preferred. The content of the alkyl methacrylate(s) is preferably from 50% by weight or less, more preferably 45% by weight or less, even more preferably 15% by weight or less, still more preferably 10% by weight or less based on the total weight of monomer component used to form each of the (meth)acryl copolymer (B).

Examples of the aromatic ring-containing (meth)acrylic monomer include benzyl (meth)acrylate, phenyl (meth)acrylate, o-phenylphenol (meth)acrylate, phenoxy(meth)acrylate, phenoxyethyl (meth)acrylate, phenoxypropyl (meth)acrylate, phenoxydiethylene glycol (meth)acrylate, ethylene oxide-modified nonylphenol (meth)acrylate, ethylene oxide-modified cresol (meth)acrylate, phenol ethylene oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, polystyryl (meth)acrylate, and other benzene ring-containing (meth)acrylates; hydroxyethylated β-naphthol acrylate, 2-naphthoethyl (meth)acrylate, 2-naphthoxyethyl acrylate, 2-(4-methoxy-1-naphthoxy)ethyl (meth)acrylate, and other naphthalene ring-containing (meth)acrylates; and biphenyl (meth)acrylate and other biphenyl ring-containing (meth)acrylates. Among them, benzyl (meth)acrylate and phenoxyethyl (meth)acrylate are more preferred, and benzyl (meth)acrylate is particularly preferred, in view of adhesive properties and durability.

The content of the aromatic ring-containing (meth)acrylic monomer which is included in the (meth)acryl copolymer (B) as a monomer unit, is from 1 to 28% by weight, preferably from 4 to 28% by weight, more preferably from 4 to 26% by weight, even more preferably from 8 to 24% by weight based on the total weight of monomer component used to form the (meth)acryl copolymers (A) and (B). If the content of the aromatic ring-containing (meth)acrylic monomer which is included in the (meth)acryl copolymer (B) as a monomer unit, is below the specified range, durability to heat and humidity or the display unevenness-preventing effect may be insufficient. If the content of the aromatic ring-containing (meth)acrylic monomer is above the specified range, the pressure-sensitive adhesive composition itself may degrade, and the pressure-sensitive adhesive layer made from the pressure-sensitive adhesive composition may easily deform, so that an optical film with the pressure-sensitive adhesive layer formed thereon may cause worse display unevenness. In the invention, the aromatic ring-containing (meth)acrylic monomer is contained at a content in the specified range to form the shell layer. This feature can prevent the above-mentioned degradation of the pressure-sensitive adhesive layer, prevent display unevenness (peripheral unevenness or corner unevenness), which would otherwise be caused by a white spot at a peripheral part of an optical film with the pressure-sensitive adhesive layer formed thereon, and provide a sufficient level of durability to hot and humid environments (durability to heat and humidity).

The content of the aromatic ring-containing (meth)acrylic monomer which is included in the (meth)acryl copolymer (B) as a monomer unit, is preferably from 5 to 40% by weight, more preferably 5 to 35% by weight, even more preferably 10 to 30% by weight based on the total weight of monomer component used to form the (meth)acryl-based copolymer (B). In a preferred mode, when the content of the aromatic ring-containing (meth)acrylic monomer in the (meth)acrylic copolymer (B) is in these ranges, the content of the aromatic ring-containing (meth)acrylic monomer in the emulsion particles can fall within the specified range.

To improve the tackiness of the pressure-sensitive adhesive and provide stability for the emulsion, the monomer component used to form each of the (meth)acryl copolymer (B) preferably contains a carboxyl group-containing monomer. The carboxyl group-containing monomer may be monomer having a carboxyl group and a radically-polymerizable unsaturated double bond-containing group such as a (meth)acryloyl group or a vinyl group, examples of which include (meth)acrylic acid, itaconic acid, maleic acid, fumaric acid, crotonic acid, carboxyethyl acrylate, and carboxypentyl acrylate.

The content of the carboxyl group-containing monomer is preferably from 0.1 to 8% by weight, more preferably from 0.5 to 7% by weight, even more preferably from 1 to 6% by weight based on the total weight of monomer component used to form each of the (meth)acryl copolymer (B).

The monomer component used to form each of the (meth)acryl copolymer (B) may contain a phosphate group-containing monomer. For example, the phosphate group-containing monomer may be a phosphate group-containing monomer represented by formula (1) below.

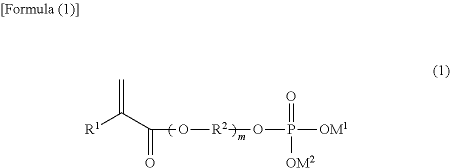

In formula (1), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m represents the degree of polymerization of the oxyalkylene groups (—O—R²—), m is 2 or more, preferably 4 or more, generally 40 or less. The polyoxyalkylene group may be a polyoxyethylene group or a polyoxypropylene group, and these polyoxyalkylene groups may include random, block, or graft units. The cation of the salt of the phosphate group is, but not limited to, an inorganic cation such as an alkali metal such as sodium or potassium or an alkaline-earth metal such as calcium or magnesium, or an organic cation such as a quaternary amine.

The content of the phosphate group-containing monomer is preferably 20% by weight or less, more preferably from 0.1 to 20% by weight, even more preferably 0.1 to 10% by weight, based on the total weight of monomer component used to form each of the (meth)acryl copolymer (B). The content of more than 20% by weight is not preferable in view of polymerization stability.

The monomer component used to form each of the (meth)acryl copolymer (B) may contain an alkoxysilyl group-containing monomer. The alkoxysilyl group-containing monomer may be a silane coupling agent-type unsaturated monomer having an alkoxysilyl group and at least one unsaturated double bond, such as a (meth)acryloyl group or a vinyl group. The alkoxysilyl group-containing monomer is preferred in order to allow the (meth)acryl copolymer (B) to have a crosslinked structure and improved adhesion to glass.

Examples of the alkoxysilyl group-containing monomer include an alkoxysilyl group-containing (meth)acrylate monomer and an alkoxysilyl group-containing vinyl monomer. Examples of the alkoxysilyl group-containing (meth)acrylate monomer include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. For example, alkoxysilyl group-containing vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

The content of the alkoxysilyl group-containing monomer is preferably from 0.001 to 1% by weight, more preferably from 0.01 to 0.5% by weight, and even more preferably from 0.03 to 0.1% by weight based on the total weight of monomer component used to form each of the (meth)acryl copolymer (B). If it is less than 0.001% by weight, the effect of using the alkoxysilyl group-containing monomer (providing a crosslinked structure and adhesion to glass) may be insufficiently obtained. If it is more than 1% by weight, the pressure-sensitive adhesive layer may have a too high degree of crosslinkage, so that the pressure-sensitive adhesive layer may crack over time.

The monomer component used to form each of the (meth)acryl copolymer (B) may further contain one or more copolymerizable monomers having an unsaturated double bond-containing polymerizable functional group such as a (meth)acryloyl group or a vinyl group, in addition to the alkyl (meth)acrylate, the aromatic ring-containing (meth)acrylic monomer, the carboxyl group-containing monomer, the phosphate group-containing monomer, and the alkoxysilyl group-containing monomer. The copolymerizable monomer or monomers may be added to the monomer component for purposes such as stabilization of the aqueous dispersion, improvement of the tackiness of the pressure-sensitive adhesive layer to a substrate such as an optical film, and improvement of the initial adhesion to the adherend.

Examples of copolymerizable monomers include acid anhydride group-containing monomers such as maleic anhydride and itaconic anhydride; vinyl esters such as vinyl acetate and vinyl propionate; styrene monomers such as styrene; epoxy group-containing monomers such as glycidyl (meth)acrylate and methylglycidyl (meth)acrylate; hydroxyl group-containing monomers such as 2-hydroxyethyl (meth)acrylate and 2-hydroxypropyl (meth)acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

A polyfunctional monomer may also be used as the copolymerizable monomer for a purpose such as control of the gel fraction of the water-dispersible pressure-sensitive adhesive composition for an optical film. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; diacetone acrylamide; and compounds having two or more reactive unsaturated double bonds which have different reactivity respectively, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

When a monofunctional monomer is used as the copolymerizable monomer, the content of the copolymerizable monomer is preferably 20% by weight or less, more preferably 10% by weight or less, and even more preferably 5% by weight or less based on the total weight of monomer component used to form each of the (meth)acryl copolymer (B), in view of the stability of the emulsion and prevention of an excessive increase in the viscosity of the emulsion. When a polyfunctional monomer is used as the copolymerizable monomer, the content of the copolymerizable monomer is preferably 5% by weight or less, more preferably 3% by weight or less, and even more preferably 1% by weight or less based on the total weight of monomer component used to form each of the (meth)acryl copolymer (B) in view of the stability of the emulsion.

The (meth)acryl copolymer (A) that forms the core layer includes a monomer unit derived from an alkyl (meth)acrylate.

In view of emulsion polymerization reactivity, the alkyl (meth)acrylate used to form the (meth)acryl copolymer (A) preferably has a water solubility in a specific range, and an alkyl methacrylate having an alkyl group of 1 to 18 carbon atoms which are listed above for the (meth)acryl copolymer (B) is preferably used to form a major component, so that the glass transition temperature can be easily controlled. The alkyl methacrylates may be used alone or in combination of two or more. Examples of the alkyl methacrylate may be the same as those listed above. In particular, methyl methacrylate, ethyl methacrylate, tert-butyl methacrylate, isobornyl methacrylate, and cyclohexyl methacrylate are preferred among those listed above. The alkyl methacrylate preferably makes up 60 to 100% by weight, more preferably 70 to 99.9% by weight, even more preferably 80 to 99.9% by weight, further more preferably 80 to 95% by weight based on the total weight of monomer component used to form the (meth)acryl copolymer (A).

Alkyl acrylate having an alkyl group of 1 to 18 carbon atoms which are listed above for the (meth)acryl copolymer (B), may also be used to form the (meth)acryl copolymer (A), because the material should preferably have a water solubility in a certain range in view of its reactivity in emulsion polymerization and the use of the alkyl acrylate having an alkyl group of 1 to 18 carbon atoms makes it easy to control the glass transition temperature. The alkyl acrylates may be used alone or in combination of two or more. Examples of the alkyl acrylate may be the same as those listed above. In particular, an alkyl acrylate having an alkyl group of 3 to 9 carbon atoms such as propyl acrylate, n-butyl acrylate, 2-ethylhexyl acrylate, or n-octyl acrylate is preferred among those listed above. The alkyl acrylate preferably makes up 40% by weight or less, more preferably 5 to 30% by weight, even more preferably 5 to 20% by weight based on the total weight of monomer component used to form the (meth)acryl copolymer (A).

The monomer component used to form the (meth)acryl copolymer (A) preferably contains a carboxyl group-containing monomer. Examples of the carboxyl group-containing monomer may be the same as those listed for the (meth)acryl copolymer (B). The content of the carboxyl group-containing monomer is preferably 0.1 to 8% by weight, more preferably 0.5 to 7% by weight, even more preferably 1 to 5% by weight based on the total weight of monomer component used to form the (meth)acryl copolymer (A).

The (meth)acryl copolymer (A) may also include a monomer unit derived from a phosphate group-containing monomer, an alkoxysilyl group-containing monomer, or a copolymerizable monomer, examples of which are listed above for the (meth)acryl copolymer (B). Examples of the phosphate group-containing monomer, the alkoxysilyl group-containing monomer, or the copolymerizable monomer may be the same as those listed above for the (meth)acryl copolymer (B). Any of these monomers may be used at the same content as that for the (meth)acryl copolymer (B).

Like the (meth)acryl copolymer (B), the (meth)acryl copolymer (A) may include a monomer unit derived from an aromatic ring-containing acrylic monomer. In such a case, the aromatic ring-containing acrylic monomer preferably makes up 8% by weight or less, more preferably 5% by weight or less, even more preferably 3% by weight or less, furthermore preferably 1% by weight or less based on the total weight of monomer component used to form the (meth)acryl copolymer (A). In particular, however, the (meth)acryl copolymer (A) is preferably free of any monomer unit derived from an aromatic ring-containing acrylic monomer.

The glass transition temperature of the (meth)acryl copolymer (B) used to form the shell layer is not limited and may be set at any appropriate level, for example, which is preferably from −55° C. to less than 0° C., more preferably from −55° C. to −5° C., even more preferably from −50° C. to −5° C. The glass transition temperature of the (meth)acryl copolymer (A) used to form the core layer is not limited and may be set at any appropriate level, for example, which is preferably from 0° C. to 180° C., more preferably from 0° C. to 150° C., even more preferably from 10° C. to 130° C.

The glass transition temperature of the (meth)acryl copolymer (B) is preferably lower than that of the (meth)acryl copolymer (A). The difference ((A)-(B)) between the glass transition temperatures of the (meth)acryl copolymers (A) and (B) is preferably, but not limited to, more than 0° C., more preferably 10° C. or more, even more preferably 40° C. or more, further more preferably 50° C. or more.

The glass transition temperatures of the (meth)acryl copolymer (A) and (meth)acryl copolymer (B) is theoretical values each calculated from the FOX equation taking into account the types and contents of the monomer units of each polymer. FOX equation:

$$\frac{1}{Tg} = \frac{{W}_{1}}{{Tg}_{1}} + \frac{{W}_{2}}{{Tg}_{2}} + … + \frac{{W}_{n}}{{Tg}_{n}} \qquad [ math 1 ]$$

(Tg: the glass transition temperature (K) of the polymer; Tg₁, Tg₂, . . . Tgₙ: the glass transition temperatures (K) of the homopolymers of the respective monomers; W₁, W₂, . . . Wₙ: the weight fractions of the respective monomers).

It should be noted that the glass transition temperatures of the (meth)acryl copolymers (A) and (meth)acryl copolymers (B) are calculated based on the monofunctional monomers. Namely, even when the polymers each contain a polyfunctional monomer as a monomer unit, the polyfunctional monomer is neglected in the calculation of the glass transition temperature, because the polyfunctional monomer is used in a small amount so that its influence on the glass transition temperature of the copolymer is low. The phosphate group-containing monomer has a low contribution to the glass transition temperature of the copolymers and therefore is not taken into account for the calculation of the glass transition temperature. In addition, the alkoxysilyl-group containing monomer can be regarded as the polyfunctional monomer and therefore is not taken into account for the calculation of the glass transition temperature. The theoretical glass transition temperature calculated from the FOX equation above well agrees with the glass transition temperature measured by differential scanning calorimetry (DSC) or dynamic viscoelasticity measurement.

The emulsion particles with a core-shell structure preferably each include the (meth)acryl copolymer (A) and the (meth)acryl copolymer (B) in a solid weight ratio (A)/(B) of 5/95 to 50/50 in a single emulsion particle. This ratio is based on 100% by weight of the total of the (meth)acryl copolymers (A) and (B). The emulsion particles including the (meth)acryl copolymers (A) and (B) in a ratio within this range is preferable in order to improve durability to heat and humidity and to prevent display unevenness. In other words, the emulsion particles should include 50 to 95% by weight of the (meth)acryl copolymer (B) in the form of a shell layer and 5 to 50% by weight of the (meth)acryl copolymer (A) in the form of a core layer based on 100% by weight of the total of the copolymers (A) and (B). The content of the (meth)acryl copolymer (B) is preferably 60% by weight or more, more preferably 70% by weight or more. The (meth)acryl copolymer (B) at a content of less than 50% by weight may be insufficiently effective for durability to heat and humidity or for the prevention of display unevenness. On the other hand, the (meth)acryl copolymer (B) is preferably used at a content of 95% by weight or less, more preferably at a content of 85% by weight or less.

The emulsion particles with the core-shell structure can be obtained by a multi-stage emulsion polymerization process that includes forming the copolymer for the core layer by emulsion polymerization and then forming the copolymer for the shell layer by emulsion polymerization in the presence of the copolymer for the core layer. Specifically, in each emulsion polymerization stage, the monomer component for forming the copolymer for the core or shell layer is polymerized in water in the presence of a surfactant (emulsifier) and a radical polymerization initiator, so that the copolymer for the core or shell layer is formed.

Emulsion polymerization of the monomer component may be performed by a conventional process. In the emulsion polymerization, for example, the monomer components, a surfactant (an emulsifying agent), and a radical polymerization initiator, and optionally a chain transfer agent or the like are mixed as appropriate. More specifically, for example, a known emulsion polymerization method may be employed, such as a batch mixing method (batch polymerization method), a monomer dropping method, or a monomer emulsion dropping method. In the monomer dropping method, or the monomer emulsion dropping method continuous dropping or divided dropping is appropriately selected. These methods may be appropriately combined. While reaction conditions and so on may be appropriately selected, for example, the polymerization temperature is preferably from about 40 to about 95° C., and the polymerization time is preferably from about 10 minutes to about 24 hours.

The surfactant (emulsifying agent) for use in the emulsion polymerization may be, but not limited to, any of various surfactants commonly used in emulsion polymerization. As the surfactant, an anionic or a nonionic surfactant is generally used. Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodium monooctyl sulfosuccinate, sodium dioctyl sulfosuccinate, and sodium polyoxyethylene lauryl sulfosuccinate, and derivatives thereof; and polyoxyethylene distyrenated phenyl ether sulfate ester salts. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Besides the above non-reactive surfactants, a reactive surfactant having a radical-polymerizable functional group containing an ethylenic unsaturated double bond may be used as the surfactant. The reactive surfactant may be a radical-polymerizable surfactant prepared by introducing a radical-polymerizable functional group (radically reactive group) such as a propenyl group or an allyl ether group into the anionic surfactant or the nonionic surfactant. These surfactants may be appropriately used alone or in any combination. Among these surfactants, the radical-polymerizable surfactant having a radical-polymerizable functional group is preferably used in view of the stability of the aqueous dispersion or the heat resistance and moisture resistance of the pressure-sensitive adhesive layer.

Examples of anionic reactive surfactants include alkyl ether surfactants (examples of commercially available products include AQUALON KH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-20 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, HS-1025, BC-05, BC-10, and BC-20 manufactured by Dai-ichi Kogyo Seiyaku Co., Ltd., andADEKAREASOAPSDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd., ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd, and others).

The surfactant is preferably added in an amount of 1 to 50 parts by weight, more preferably 1 to 40 parts by weight, even more preferably 5 to 30 parts by weight, based on 100 parts by weight of the monomer component used to form each of the (meth)acryl copolymer (A). The surfactant is preferably added in an amount of 0.1 to 10 parts by weight, more preferably 0.1 to 3 parts by weight, even more preferably 0.3 to 3 parts by weight, based on 100 parts by weight of the monomer component used to form each of the (meth)acryl copolymer (B). The addition of the surfactant in such an amount can improve adhesive properties and stability such as polymerization stability or mechanical stability.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide.

The content of the radical polymerization initiator is typically from about 0.02 to about 1 part by weight, preferably from 0.02 to 0.5 parts by weight, more preferably from 0.05 to 0.3 parts by weight, based on 100 parts by weight of the monomer components, while it is appropriately selected. If it is less than 0.02 parts by weight, the radical polymerization initiator may be less effective. If it is more than 1 part by weight, the (meth)acryl polymer (A) or (meth)acryl polymer (B) in the aqueous dispersion (polymer emulsion) may have a reduced molecular weight, so that the water-dispersible pressure-sensitive adhesive may have reduced durability. In the case of a redox system initiator, the reducing agent is preferably used in an amount of 0.01 to 1 part by weight based on 100 parts by weight of the total amount of the monomer components.

A chain transfer agent is optionally used to control the molecular weight of the (meth)acryl polymer. In general, chain transfer agents commonly used in emulsion polymerization are used. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is 0.3 parts by weight or less, preferably from 0.001 to 0.3 parts by weight, based on 100 parts by weight of the monomer components.

In general, the weight average molecular weight of the (meth)acryl polymer (A) or (meth)acryl polymer (B) is preferably 1,000,000 or more, more preferably 1,000,000 to 4,000,000. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has a high gel content and cannot be subjected to GPC (gel permeation chromatography) measurement, which means that it is often difficult to identify the molecular weight by actual measurement.

The water-dispersible pressure-sensitive adhesive composition for an optical film contains, as a main component, the emulsion particles with the core-shell structure. In the process of preparing the emulsion particles with the core-shell structure, an emulsion of the (meth)acryl copolymer (A) and an emulsion of the (meth)acryl copolymer (B), which are not involved in forming the core-shell structure, can be produced. Therefore, the water-dispersible pressure-sensitive adhesive composition for an optical film may also contain an emulsion of the (meth)acryl copolymer (A) and an emulsion of the (meth)acryl copolymer (B) in addition to the emulsion particles with the core-shell structure.

If necessary, the water-dispersible pressure-sensitive adhesive composition of the invention may contain a crosslinking agent in addition to the emulsion particles with the core-shell structure, emulsion particles of the (meth)acryl copolymer (A), and emulsion particles of the (meth)acryl copolymer (B). The crosslinking agent may be an isocyanate crosslinking agent, an epoxy crosslinking agent, an oxazoline crosslinking agent, an aziridine crosslinking agent, a carbodiimide crosslinking agent, a metal chelate crosslinking agent, or any other crosslinking agent commonly used in the art. When the (meth)acryl copolymer has a functional group, these crosslinking agents can have the effect of reacting with the functional group to form crosslinks.

In general, the content of the crosslinking agent is preferably, but not limited to, about 10 parts by weight or less (on a solids basis) based on 100 parts by weight of the total solids in the water-dispersible pressure-sensitive adhesive composition for an optical film. It should be noted that the use of the crosslinking agent can tend to reduce the tackiness although the crosslinking agent can impart additional cohesive strength to the pressure-sensitive adhesive layer.

If necessary, the water-dispersible pressure-sensitive adhesive composition of the invention may contain any of various additives such as viscosity modifiers, release modifiers, tackifiers, plasticizers, softeners, glass fibers, glass beads, metal powders, fillers made of other inorganic powders, pigments, colorants (such as pigments and dyes), pH regulators (acids or bases), antioxidants, ultraviolet absorbers, and silane coupling agents without departing from the objects of the invention. The composition may also contain fine particles so that the composition can form a pressure-sensitive adhesive layer having light diffusing properties. Any of these additives may also be added in the form of an emulsion. In this regard, the content of any of these additives is preferably 10 parts by weight or less based on 100 parts by weight of the total solids in the water-dispersible pressure-sensitive adhesive composition for an optical film.

The emulsion particles in the water-dispersible pressure-sensitive adhesive composition for an optical film of the invention preferably has a volume average particle size of 40 to 150 nm, more preferably 40 to 140 nm, even more preferably 50 to 130 nm, still more preferably 80 to 120 nm.

2. Pressure-Sensitive Adhesive Layer

The pressure-sensitive adhesive layer of the invention is made from the water-dispersible pressure-sensitive adhesive composition for an optical film. The pressure-sensitive adhesive layer can be formed by a process including applying the water-dispersible pressure-sensitive adhesive composition for an optical film to a substrate (an optical film or a release film) and then drying the adhesive.

Various methods may be used in the applying step of the water-dispersible pressure-sensitive adhesive composition for an optical film. Examples include roll coating, kiss roll coating, gravure coating, reverse coating, roll brush coating, spray coating, dip roll coating, bar coating, knife coating, air knife coating, curtain coating, lip coating, and extrusion coating using a die coater or the like.

In the applying step, the amount of the application should be controlled so that a pressure-sensitive adhesive layer with a predetermined thickness (post-drying thickness) can be formed. The thickness (post-drying thickness) of the pressure-sensitive adhesive layer is generally set within the range of about 1 μm to about 100 μm, preferably within the range of 5 μm to 50 μm, and more preferably within the range of 10 μm to 40 μm.

In the process of forming the pressure-sensitive adhesive layer, the water-dispersible pressure-sensitive adhesive composition applied for an optical film is then subjected to drying. The drying temperature and the drying time may be selected as appropriate and, for example, may be about 80 to about 170° C. and about 0.5 to about 30 minutes, respectively.

The pressure-sensitive adhesive layer of the invention preferably has a haze of 1% or less, more preferably 0 to 0.8% when having a thickness of 25 μm. The pressure-sensitive adhesive layer with a haze of 1% or less can satisfy the level of transparency required for use on optical members. The pressure-sensitive adhesive layer with a haze of more than 1% may cause depolarization, which is not preferred for optical applications. The haze can be measured by known methods.

Examples of the material used to form the release film include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, apolybutadiene film, apolymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release film may be used as is as a separator for a pressure-sensitive adhesive layer-attached optical film, so that the process can be simplified.

The water-dispersible pressure-sensitive adhesive composition of the invention for an optical film and the pressure-sensitive adhesive layer of the invention are, for example, preferably used for optical film applications as described below. In addition, they can be used for various other applications such as optical protective tapes, transparent double-sided pressure-sensitive adhesive tapes, and transparent pressure-sensitive adhesive tapes.

3. Pressure-Sensitive Adhesive Optical Film

The pressure-sensitive adhesive optical film of the invention includes an optical film and the pressure-sensitive adhesive layer or layers provided on one or both sides of the optical film. The pressure-sensitive adhesive optical film of the invention is formed through the process descried above, which includes applying the water-dispersible pressure-sensitive adhesive composition to an optical film or a release film and then drying the composition. When formed on the release film, the pressure-sensitive adhesive layer is bonded and transferred onto an optical film.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film is, but not limited to the kinds, used for forming image display device such as liquid crystal display. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 5 to 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film may be exemplified as other optical layers, such as a reflective plate, a transflective plate, a retardation plate (a half wavelength plate and a quarter wavelength plate included), a viewing angle compensation film, a brightness enhancement film, a surface treatment film or the like, which may be used for formation of a liquid crystal display etc. These are used in practice as an optical film, or as one layer or two layers or more of optical layers laminated with polarizing plate.

The surface treatment film may also be provided on and bonded to a front face plate. Examples of the surface treatment film include a hard-coat film for use in imparting scratch resistance to the surface, an antiglare treatment film for preventing glare on image display devices, and an anti-reflection film such as an anti-reflective film or a low-reflective film, etc. The front face plate is provided on and bonded to the surface of an image display device such as a liquid crystal display device, an organic EL display device, a CRT, or a PDP to protect the image display device or to provide a high-grade appearance or a differentiated design. The front face plate is also used as a support for a λ/4 plate in a 3D-TV. In a liquid crystal display device, for example, the front face plate is provided above a polarizing plate on the viewer side. When the pressure-sensitive adhesive layer according to the present invention is used, the same effect can be produced using a plastic base material such as a polycarbonate or poly (methyl methacrylate) base material for the front face plate, as well as using a glass base material.

Although an optical film with the above described optical layer laminated to the polarizing plate may be formed by a method in which laminating is separately carried out sequentially in manufacturing process of a liquid crystal display device or the like, an optical film in a form of being laminated beforehand has an outstanding advantage that it has excellent stability in quality and assembly workability, and thus manufacturing processes ability of a liquid crystal display device or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

4. Image Display Device

The pressure-sensitive adhesive optical film of the present invention is preferably used to form various types of image display devices such as liquid crystal display devices. Liquid crystal display devices may be produced according to conventional techniques. Specifically, liquid crystal display devices are generally produced by appropriately assembling a liquid crystal cell or the likes and the pressure-sensitive adhesive optical film and optionally other components such as a lighting system and incorporating a driving circuit according to any conventional technique, except that the pressure-sensitive adhesive optical film of the present invention is used. Any type of liquid crystal cell may also be used such as a TN type, an STN type, a n type, a VA type and an IPS type.

Suitable liquid crystal display devices, such as liquid crystal display device with which the above pressure-sensitive adhesive optical film has been provided on one side or both sides of the display panel such as a liquid crystal cell, and with which a backlight or a reflective plate is used for a lighting system may be manufactured. In this case, the pressure-sensitive adhesive optical film of the present invention may be provided on one side or both sides of the display panel such as a liquid crystal cell. When providing the optical films on both sides, they may be of the same type or of different type. Furthermore, in assembling a liquid crystal display device, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display device: OLED) will be explained. Generally, in organic EL display device, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer including triphenylamine derivatives etc., a luminescence layer including fluorescent organic solids, such as anthracene; a laminated material of electronic injection layer including such a luminescence layer and perylene derivatives, etc.; laminated material of these hole injection layers, luminescence layer, and electronic injection layer etc.

An organic EL display device emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in an intermediate process is the same as a mechanism in common diodes, and, as is expected, there is a strong non-linear relationship between electric current and luminescence strength accompanied by rectification nature to applied voltage.

In an organic EL display device, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display device of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display device looks like mirror if viewed from outside.

In an organic EL display device containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to n/4, the mirror surface of the metal electrode may be completely covered.

This means that only linearly polarized light component of the external light that enters as incident light into this organic EL display device is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

### EXAMPLES

Hereinafter, the invention will be more specifically described with reference to examples, which, however, are not intended to limit the invention. In each example, “parts” and “%” are all by weight.

### Production Example 1

### Production of Undercoat Layer-Bearing Polarizing Film

EPOCROS WS-700 (manufactured by NIPPON SHOKUBAI CO., LTD.) was diluted with a mixed solution of isopropyl alcohol (IPA) and water (IPA/water (weight ratio)=1/1) to form a solution of 0.25% by weight EPOCROS WS-700. The solution was applied to a polarizing film (SEG-DU (trade name) manufactured by Nitto Denko Corporation) with a Mayer rod and then heat-treated at 40° C. for 1 minute to forma 50-nm-thick undercoat layer-bearing polarizing film.

### Example 1

### Preparation of Monomer Emulsion (1)

A monomer emulsion (1) was prepared by adding 130 parts of butyl acrylate, 800 parts of methyl methacrylate, 50 parts of cyclohexyl methacrylate, 20 parts of acrylic acid, 0.4 parts of 3-methacryloyloxypropyl-triethoxysilane (KBM-503 (trade name) manufactured by Shin-Etsu Chemical Co., Ltd.), 440 parts of AQUALON HS-1025 (25% aqueous solution, manufactured by DKS Co. Ltd.), and 4,150 parts of water as raw materials to a glass beaker and stirring them at 6,000 rpm for 5 minutes with a homomixer (manufactured by PRIMIX Corporation).

### Preparation of Monomer Emulsion (2)

A monomer emulsion (2) was prepared by adding 767 parts of butyl acrylate, 100 parts of benzyl acrylate (Viscoat #160 (trade name) manufactured by Osaka Organic Chemical Industry Ltd.), 50 parts of cyclohexyl methacrylate, 25 parts of a phosphate group-containing monomer (Sipomer PAM-200 (trade name) manufactured by Rhodia Nicca, Ltd.), 58 parts of acrylic acid, 0.4 parts of 3-methacryloyloxypropyl-triethoxysilane (KBM-503 (trade name) manufactured by Shin-Etsu Chemical Co., Ltd.), 40 parts of AQUALON HS-1025 (25% aqueous solution, manufactured by DKS Co. Ltd.), and 1,080 parts of water as raw materials to a glass beaker and stirring them at 6,000 rpm for 5 minutes with a homomixer (manufactured by PRIMIX Corporation).

(Preparation of Water-Dispersible Pressure-Sensitive Adhesive Composition for Optical Film)

A reaction vessel equipped with a condenser tube, a nitrogen inlet tube, a thermometer, a dropping funnel, and a stirring blade was charged with 559 parts of the monomer emulsion (1) prepared as described above. Subsequently, after the reaction vessel was sufficiently purged with nitrogen, the temperature of the inner bath was adjusted to 65° C. Subsequently, after 0.1 parts (on a solid basis) of a sodium ammonium peroxosulfate (APS) aqueous solution (5%) was added to the reaction vessel, the mixture was subjected to batch polymerization with stirring at a rate of 150 rpm (inner bath temperature: 65° C., polymerization time: 2 hours). After the batch polymerization, 0.5 parts (on a solid basis) of a sodium ammonium peroxosulfate (APS) aqueous solution (5%) was added to the reaction vessel, and then the mixture was subjected to polymerization for 10 minutes with the inner bath temperature kept at 65° C. to form a copolymer for a core layer. Subsequently, 848 parts of the monomer emulsion (2) was added dropwise to the reaction vessel over 3 hours with the inner bath temperature kept at 65° C. The mixture was then subjected to polymerization for 3 hours to form a shell layer, so that an aqueous dispersion containing polymer emulsion particles with a core-shell structure was obtained. Subsequently, after the aqueous dispersion containing polymer emulsion particles with a core-shell structure was cooled to room temperature, the pH of the aqueous dispersion was adjusted to 7.8 by adding 10% ammonia water, so that an water-dispersible pressure-sensitive adhesive composition containing emulsion particles with a core-shell structure was obtained. The resulting polymer emulsion particles had a volume average particle size of 108 nm.

(Preparation of Pressure-Sensitive Adhesive Optical Film)

The prepared water-dispersible pressure-sensitive adhesive composition was applied to a silicone release agent-coated, 38-μm-thick film (MRF-38 (trade name) manufactured by Mitsubishi Plastics, Inc.) by die coating (coating speed: 5 m/minute) and then dried at 120° C. for 2 minutes to form a 25-μm-thick pressure-sensitive adhesive layer, which was then transferred onto the undercoat layer of the undercoat layer-bearing polarizing film obtained in Production Example 1, so that a pressure-sensitive adhesive optical film was obtained.

### Examples 2 and 3

Pressure-sensitive adhesive optical films were formed as in Example 1, except that the composition of the monomer emulsion (2) was changed as shown in Table 1 in the preparation of the monomer emulsion (2).

### Comparative Example 1

### Preparation of Monomer Emulsion

A monomer emulsion (3) was prepared by adding 720 parts of butyl acrylate, 160 parts of methyl methacrylate, 50 parts of cyclohexyl methacrylate, 20 parts of a phosphate group-containing monomer (Sipomer PAM-200 (trade name) manufactured by Rhodia Nicca, Ltd.), 50 parts of acrylic acid, 0.4 parts of 3-methacryloyloxypropyl-triethoxysilane (KBM-503 (trade name) manufactured by Shin-Etsu Chemical Co., Ltd.), 40 parts of AQUALON HS-1025 (25% aqueous solution, manufactured by DKS Co. Ltd.), and 1,080 parts of water as raw materials to a vessel and stirring them at 6,000 rpm for 5 minutes with a homomixer (manufactured by PRIMIX Corporation).

(Preparation of Water-Dispersible Pressure-Sensitive Adhesive Composition for Optical Film)

To a reaction vessel equipped with a condenser tube, a nitrogen inlet tube, a thermometer, a dropping funnel, and a stirring blade were added 307 parts of water and 40 parts of AQUALON HS-1025 (manufactured by DKS Co. Ltd.) and stirred at 150 rpm for 60 minutes under a nitrogen atmosphere. Subsequently, 212 parts of the monomer emulsion (3) prepared as described above was added to the reaction vessel, and then 0.01 parts (on a solid basis) of a sodium ammonium peroxosulfate (APS) aqueous solution (5%) was added to the reaction vessel at an inner bath temperature of 65° C. The mixture was then subjected to batch polymerization with stirring at a rate of 150 rpm (inner bath temperature: 65° C., polymerization time: 2 hours). After the batch polymerization, 0.05 parts (on a solid basis) of a sodium ammonium peroxosulfate (APS) aqueous solution (5%) was added to the reaction vessel, and then the mixture was subjected to polymerization for 10 minutes with the inner bath temperature kept at 65° C. to form a copolymer for a core layer. Subsequently, 212 parts of the monomer emulsion (3) was added dropwise to the reaction vessel over 3 hours with the inner bath temperature kept at 65° C. The mixture was then subjected to polymerization for 3 hours to form a shell layer, so that an aqueous dispersion containing polymer emulsion particles with a core-shell structure was obtained, in which the core and shell layers had the same composition. Subsequently, after the aqueous dispersion containing polymer emulsion particles with a core-shell structure was cooled to room temperature, the pH of the aqueous dispersion was adjusted to 7.8 by adding 10% ammonia water, so that a water-dispersible pressure-sensitive adhesive composition containing emulsion particles with a core-shell structure was obtained. The resulting polymer emulsion particles had a volume average particle size of 107 nm.

(Preparation of Pressure-Sensitive Adhesive Optical Film)

The prepared water-dispersible pressure-sensitive adhesive composition for an optical film was applied to a silicone release agent-coated, 38-μm-thick film (MRF-38 (trade name) manufactured by Mitsubishi Plastics, Inc.) by die coating (coating speed: 5 m/minute) and then heated at 120° C. for 2 minutes to form a 25-μm-thick pressure-sensitive adhesive layer, which was then transferred onto the undercoat layer of the undercoat layer-bearing polarizing film obtained in Production Example 1, so that a pressure-sensitive adhesive optical film was obtained.

### Comparative Examples 2 to 7

Pressure-sensitive adhesive optical films were formed as in Example 1, except that the compositions of the monomer emulsions (1) and (2) were changed as shown in Table 1 in the preparation of the monomer emulsion (1) and the preparation of the monomer emulsion (2).

TABLE 1

| | | | | | | | | | | Volume |
|---|---|---|---|---|---|---|---|---|---|---|
| | | | | | | | Core/ | | | average |
| | Core layer | | | Shell layer | | | shell | Whole particle | | particle |
| | Composition | Composition | Tg | Composition | Composition | Tg | (weight | Composition | Composition | size |
| | of monomers | ratio (wt %) | (° C.) | of monomers | ratio (wt %) | (° C.) | ratio) | of monomers | ratio (wt %) | [nm] |
| Example 1 | BA/MMA/ | 13/80/5/2 | 71.4 | BA/BzA/ | 76.7/10/5/2.5/5.8 | −38.4 | 20/80 | BA/BzA/ | 64/8/16/5/2/5 | 108 |
| | CHMA/AA | | | CHMA/ | | | | MMA/CHMA/ | | |
| | | | | PAM200/AA | | | | PAM200/AA | | |
| Example 2 | BA/MMA/ | 13/80/5/2 | 71.4 | BA/BzA/ | 66.7/20/5/2.5/5.8 | −32.7 | 20/80 | BA/BZA/ | 56/16/16/5/2/5 | 107 |
| | CHMA/AA | | | CHMA/ | | | | MMA/CHMA/ | | |
| | | | | PAM200/AA | | | | PAM200/AA | | |
| Example 3 | BA/MMA/ | 13/80/5/2 | 71.4 | BA/BzA/ | 56.7/30/5/2.5/5.8 | −26.7 | 20/80 | BA/BzA/ | 48/24/16/5/2/5 | 109 |
| | CHMA/AA | | | CHMA/ | | | | MMA/CHMA/ | | |
| | | | | PAM200/AA | | | | PAM200/AA | | |
| Comparative | BA/MMA/ | 72/16/5/2/5 | −27.0 | BA/MMA/ | 72/16/5/2/5 | −27.0 | 20/80 | BA/MMA/ | 72/16/5/2/5 | 107 |
| Example 1 | CHMA/ | | | CHMA/ | | | | CHMA/ | | |
| | PAM200/AA | | | PAM200/AA | | | | PAM200/AA | | |
| Comparative | BA/OHMA/ | 93/5/2 | −47.8 | BA/CHMA/ | 86.7/5/2.5/5.8 | −43.8 | 20/80 | BA/CHMA/ | 88/5/2/5 | 98 |
| Example 2 | AA | | | PAM200/AA | | | | PAM200/AA | | |
| Comparative | BA/BzA/ | 73/20/5/2 | −37.3 | BA/CHMA/ | 86.7/5/2.5/5.8 | −43.8 | 20/80 | BA/BzA/ | 84/4/5/2/5 | 108 |
| Example 3 | CHMA/AA | | | PAM200/AA | | | | CHMA/ | | |
| | | | | | | | | PAM200/AA | | |
| Comparative | BA/BzA/ | 53/40/5/2 | −25.9 | BA/CHMA/ | 86.7/5/2.5/5.8 | −43.8 | 20/80 | BA/BzA/ | 80/8/5/2/5 | 118 |
| Example 4 | CHMA/AA | | | PAM200/AA | | | | CHMA/ | | |
| | | | | | | | | PAM200/AA | | |
| Comparative | BA/BzA/ | 13/80/5/2 | 0.7 | BA/CHMA/ | 86.7/5/2.5/5.8 | −43.8 | 20/80 | BA/BzA/ | 72/16/5/2/5 | 124 |
| Example 5 | CHMA/AA | | | PAM200/AA | | | | CHMA/ | | |
| | | | | | | | | PAM200/AA | | |
| Comparative | BA/MMA/ | 13/80/5/2 | 71.4 | BA/CHMA/ | 86.7/5/2.5/5.8 | −43.8 | 20/80 | BA/MMA/ | 72/16/5/2/5 | 108 |
| Example 6 | CHMA/AA | | | PAM200/AA | | | | CHMA/ | | |
| | | | | | | | | PAM200/AA | | |
| Comparative | BA/MMA/ | 13/80/5/2 | 71.4 | BA/BzA/ | 49.2/37.5/5/2.5/5.8 | −21.7 | 20/80 | BA/BzA/ | 42/30/16/5/2/5 | 116 |
| Example 7 | CHMA/AA | | | CHMA/ | | | | MMA/CHMA/ | | |
| | | | | PAM200/AA | | | | PAM200/AA | | |

In Table 1, the composition (% by weight) of the core layer indicates the proportions of all monomers used to form the core layer, and the composition (% by weight) of the shell layer indicates the proportions of all monomers used to form the shell layer. The composition (% by weight) of the whole particle indicates the proportions of the monomers used to form the whole particle including the core and shell layers.

Table 1 also shows the glass transition temperature of the (meth)acryl copolymers that form the core and shell layers, respectively, obtained in each of the examples and the comparative examples, and shows the volume average particle size of the polymer emulsion particles obtained in each of the examples and the comparative examples. The glass transition temperature and the volume average particle size are the theoretical values calculated by the following methods.

<Calculation of Glass Transition Temperature>

The glass transition temperature of the (meth)acryl copolymers of the core and shell layers of the emulsion particles in the water-dispersible pressure-sensitive adhesive composition obtained in each example for an optical film was calculated from the FOX equation below using the glass transition temperature Tg (K) of the homopolymer of each monomer shown below.

BA: Butyl acrylate (homopolymer's Tg: 219 K)
AA: Acrylic acid (homopolymer's Tg: 379.15 K)
CHMA: Cyclohexyl methacrylate (homopolymer's Tg: 356 K)
MMA: Methyl methacrylate (homopolymer's Tg: 378.15 K)
BzA: Benzyl acrylate (homopolymer's Tg: 279.15 K)
FOX equation:

$$\frac{1}{Tg} = \frac{{W}_{1}}{{Tg}_{1}} + \frac{{W}_{2}}{{Tg}_{2}} + … + \frac{{W}_{n}}{{Tg}_{n}} \qquad [ Formula 2 ]$$

wherein Tg is the glass transition temperature (K) of the polymer, Tg₁, Tg₂, . . . , Tgₙ are each the glass transition temperature (K) of the homopolymer of each monomer, and W₁, W₂, . . . , Wₙ are each the weight fraction of each monomer.

<Measurement of Volume Average Particle Size>

The volume average particle size of the polymer emulsion particles was measured as follows. The prepared water-dispersible pressure-sensitive adhesive composition containing emulsion particles with a core-shell structure was diluted with distilled water to a solid concentration of about 1% by weight. The dilution was measured for volume average particle size using the following system: analyzer, LS 13 320 manufactured by Beckman Coulter, Inc.; refractive index of PIDS mode dispersoid, 1.48; refractive index of dispersion medium using poly(n-butyl acrylate), 1.333.

The pressure-sensitive adhesive layer obtained in each of the examples and the comparative examples was evaluated as described below. Table 2 shows the evaluation results.

<Display Unevenness>

Two pieces (size: 80×50 mm) of the pressure-sensitive adhesive optical film were bonded in a crossed configuration (axial angles: 0° and 90°) to both sides of an alkali glass sheet. The resulting laminate was treated in an autoclave at 50° C. and 5 atm for 15 minutes and then stored for 75 hours under an atmosphere at a temperature of 85° C. Subsequently, after the alkali glass sheet was cooled to room temperature, whether and how light leakage occurred at the ends and corners of the optical film was determined by visual observation while one side was irradiated with a backlight in a dark room.

<Durability to Heat and Humidity>

A piece with a size of 230×310 mm was cut from the pressure-sensitive adhesive optical film of each of the examples and the comparative examples. The cut piece was bonded to a 0.7-mm-thick glass sheet (Eagle XG manufactured by Corning Incorporate). The resulting laminate was treated in an autoclave at 50° C. and 5 atm for 15 minutes and then stored under an atmosphere at a temperature of 60° C. and a humidity of 90% for 500 hours. Subsequently, how far a lifting or peeling defect extended from the end of the pressure-sensitive adhesive optical film (the maximum defect extension distance) was determined by visual observation. The defect was evaluated as follows.

◯: The maximum defect extension distance is 0 mm to 0.5 mm.

Δ: The maximum defect extension distance is more than 0.5 mm to 1.0 mm.

x: The maximum defect extension distance is more than 1.0 mm.

TABLE 2

| | Display | Durability to heat |
|---|---|---|
| | unevenness | and humidity |
| Example 1 | Absent | ∘ |
| Example 2 | Absent | ∘ |
| Example 3 | Absent | ∘ |
| Comparative | Present | x |
| Example 1 | | |
| Comparative | Present | x |
| Example 2 | | |
| Comparative | Slightly | x |
| Example 3 | present | |
| Comparative | Absent | x |
| Example 4 | | |
| Comparative | Significantly | Δ |
| Example 5 | present | |
| Comparative | Present | ∘ |
| Example 6 | | |
| Comparative | Present | ∘ |
| Example 7 | | |

1. A water-dispersible pressure-sensitive adhesive composition for an optical film,
the composition comprising:
emulsion particles each having a core-shell structure in which (A) a (meth)acryl copolymer forms a core layer and (B) a (meth)acryl copolymer forms a shell layer in a single emulsion particle, wherein
the (meth)acryl copolymer (A) comprises a monomer unit derived from an alkyl (meth)acrylate,
the (meth)acryl copolymer (B) comprises a monomer unit derived from an aromatic ring-containing (meth)acrylic monomer and a monomer unit derived from an alkyl (meth)acrylate, and
a content of the aromatic ring-containing (meth)acrylic monomer in the (meth)acryl copolymer (B) is from 1% by weight to 28% by weight based on the total weight of monomer component used to form the (meth)acryl copolymers (A) and (B).

2. The water-dispersible pressure-sensitive adhesive composition according to claim 1 for an optical film, wherein the (meth)acryl copolymer (A) has a glass transition temperature of 0° C. to 180° C., and the (meth)acryl copolymer (B) has a glass transition temperature of −55° C. to less than 0° C.

3. The water-dispersible pressure-sensitive adhesive composition according to claim 1 for an optical film, wherein the aromatic ring-containing (meth)acrylic monomer is benzyl acrylate.

4. A pressure-sensitive adhesive layer made from the water-dispersible pressure-sensitive adhesive composition according to claim 1 for an optical film.

5. A pressure-sensitive adhesive optical film comprising an optical film and the pressure-sensitive adhesive layer according to claim 4 provided on at least one side of the optical film.

6. An image display device comprising the pressure-sensitive adhesive optical film according to claim 5.
